(19) United States
(12) Patent Application Publication
(10) Pub. No.: US 2013/0072100 A1
(43) Pub. Date: Mar. 21, 2013

(54) AIR EXTRACTOR FROM A COCKPIT OF A CRAFT

(71) Applicants: Johannes Jacobus Bosman, Potchefstroom (ZA); Adrianus Stefanus Jonker, Potchefstroom (ZA)

(72) Inventors: Johannes Jacobus Bosman, Potchefstroom (ZA); Adrianus Stefanus Jonker, Potchefstroom (ZA)

(73) Assignee: NORTH-WEST UNIVERSITY, Potchefstroom (ZA)

(21) Appl. No.: 13/639,611

(22) PCT Filed: Apr. 6, 2011
(86) PCT No.: PCT/IB11/51477

§ 371 Date: Nov. 27, 2012

(30) Foreign Application Priority Data
Apr. 6, 2010 (ZA) 2010/02389

(51) Int. Cl. B64D 13/00

(52) U.S. Cl. CPC B64D 13/00
USPC 454/76

(57) ABSTRACT

A glider 10 comprises a body 12, a closed cockpit 18 and an air extractor 22 for extracting air from the cockpit. The extractor is mounted on the body in a region of negative pressure relative to general ambient or atmospheric pressure, in use. The extractor comprises a body 24 defining an inlet 28, which is in airflow communication with the cockpit 18, an outlet 32 and a flow passage 34 extending between the inlet and the outlet. An airflow conditioning arrangement 38 is mounted in the passage.

### INTRODUCTION AND BACKGROUND

This invention relates to a craft comprising a cockpit or the like, an air extractor from the cockpit and an associated method of extracting air from a cockpit of a craft.

Ventilation of a cockpit of light aircraft is important to cool the cockpit area. Ventilation air normally enters the cockpit at the front and is expelled from the aircraft into a free stream at the rear of the aircraft. The point where the ventilation air is expelled into the free stream is important and can increase the drag of the aircraft unnecessarily. This is even more important for gliders, because with gliders, every little bit of drag must be avoided, in order to achieve high performance. Further, if a canopy for the cockpit does not fit perfectly, a positive cockpit pressure relative to general ambient pressure causes air to leak out from the cockpit at the cockpit-canopy junction. This affects the airflow around the fuselage and onto the wing negatively, even resulting in flow separation with its associated drag increase.

### OBJECT OF THE INVENTION

Accordingly, it is an object of the present invention to provide a craft, an air extractor and a method of extracting air from a cockpit of a craft with which the applicant believes the aforementioned disadvantages may at least be alleviated or which may provide a useful alternative for known vents, crafts and methods of venting the cockpit of a craft.

### SUMMARY OF THE INVENTION

According to the invention, there is provided a craft comprising a body, a closed cockpit and an air extractor for extracting air from the cockpit, the extractor being mounted on the body in a region of negative pressure relative to general ambient or atmospheric pressure, in use; the extractor comprising a body defining an inlet which is in airflow communication with the cockpit, an outlet and a flow passage extending between the inlet and the outlet; and an air-flow conditioning arrangement mounted in the passage.

A craft may be in the form of a glider.

The glider may comprise an elongate fuselage and a lift providing wing comprising a first wing part on one side of the fuselage and a second wing part on an opposite side of the fuselage and the extractor may be mounted in an upper region of the fuselage, between the first and second wing parts.

The passage may be trumpet shaped with the inlet in a region thereof having a larger cross sectional area and the passage may converge towards a throat region between the inlet and the outlet.

The flow conditioning arrangement may be provided downstream of the throat.

The flow conditioning arrangement may comprise at least one deflector element, preferably comprising an aerofoil-shaped body having a head and a tail. In embodiments wherein more than one element are provided, the elements may be mounted parallel to one another, for example in louver fashion.

An angle of the at least one element relative to a main axis of the passage may be adjustable, manually or automatically.

A craft may comprise ducting leading from the cockpit to holes in regions of the body of the craft, in use, to apply boundary layer suction to the regions. Such regions may include, but is not limited to a nose of the fuselage and regions on the main wing of the craft.

Also included within the scope of the present invention is an air extractor for a cockpit of a craft comprising a body defining an inlet, an outlet and a flow passage extending between the inlet and the outlet; and an air-flow conditioning arrangement mounted in the passage.

Yet further included within the scope of the invention is a retro-fittable kit comprising an air extractor as herein defined.

According to another aspect of the invention, there is provided a method of extracting air from a cockpit of a craft, the method comprising the steps of:
utilizing movement of the craft to generate a negative pressure relative to atmospheric pressure adjacent a region of a body of the craft;
utilizing an outlet located in said region of the body and which outlet is in communication with the cockpit, to cause an airstream to move from the cockpit to the outlet; and
conditioning the airstream to mitigate separation of a boundary layer downstream of the outlet and adjacent the body.

The method may comprise the step of causing an airstream moving from the cockpit to join a free airstream adjacent the craft body, substantially tangentially.

The airstream moving from the cockpit may be caused to join the free airstream substantially tangentially, by deflecting the airstream moving from the cockpit towards an external surface of the craft body.

The method may include the step of utilizing the negative pressure in the cockpit to apply boundary layer suction to any part of the body of the craft.

### BRIEF DESCRIPTION OF THE ACCOMPANYING DIAGRAMS

The invention will now further be described, by way of example only, with reference to the accompanying diagrams wherein:

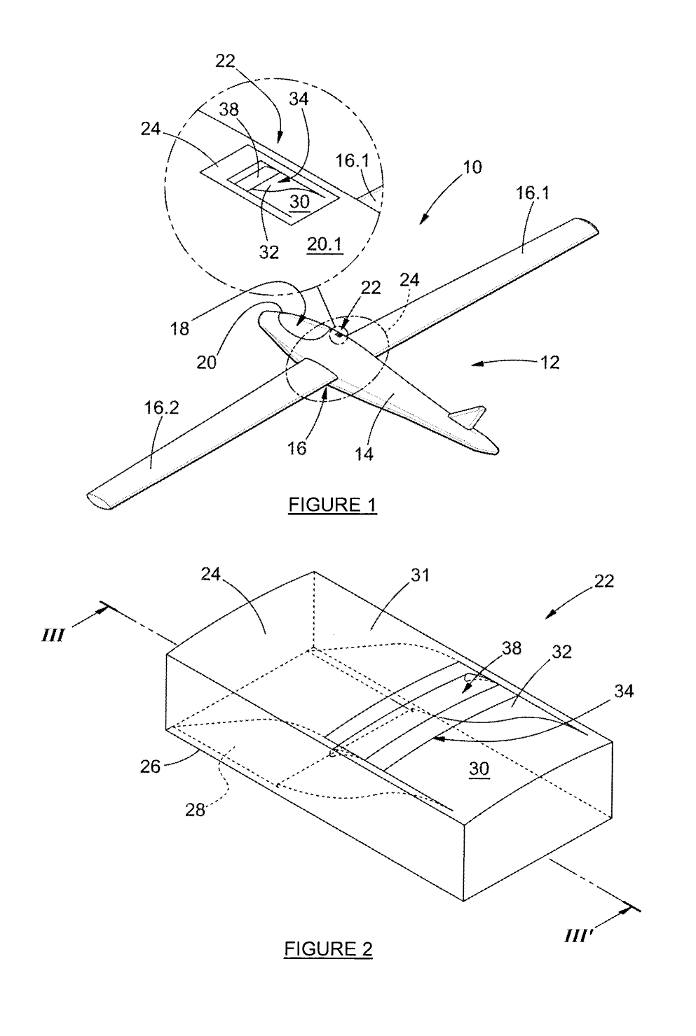

FIG. 1 is an isometric view of a craft in the form of a glider comprising an extractor for air from a cockpit of the craft;

FIG. 2 a diagrammatic perspective view of the extractor;

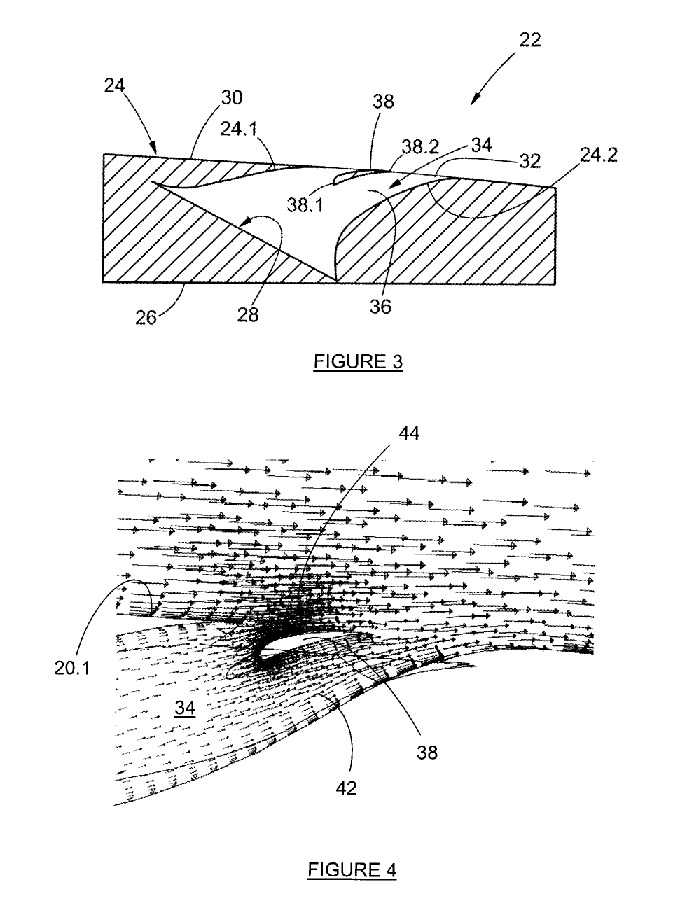

FIG. 3 is a section on line III in FIG. 2;

FIG. 4 is a diagram illustrating airflow through and past the extractor; and

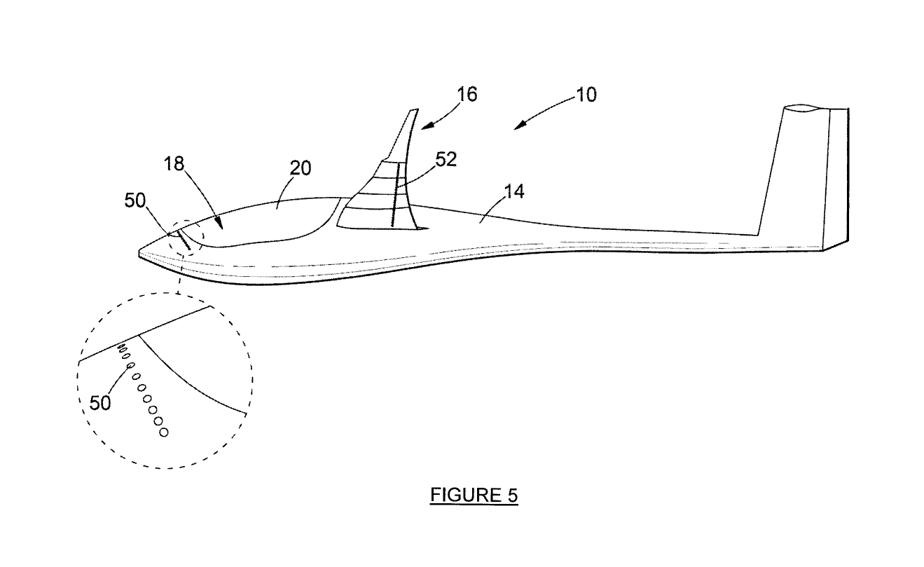

FIG. 5 is a diagrammatic sideview of the craft showing holes for applying boundary layer suction to regions of the body of the craft.

### DESCRIPTION OF A PREFERRED EMBODIMENT OF THE INVENTION

As an example embodiment, a craft in the form of a glider is generally designated by the reference numeral 10 in the diagrams.

The craft 10 comprises a body 12 comprising a fuselage 14 and a main or lift providing wing 16. The wing comprises a first part 16.1 on one side of the fuselage and a second part 16.2 on the opposite side of the fuselage. The fuselage comprises a cockpit 18 towards a front end thereof and a canopy 20 for the cockpit.

An extractor 22 for extracting air from the cockpit is mounted in a region 24 of low pressure during use, in the form of flight, of the craft. In the example embodiment shown, the region is in an upper region of the fuselage between the wing parts 16.1 and 16.2.

Referring to FIGS. 2 and 3, the extractor comprises a body 24 having an upper surface 30. The body 24 defines an inlet 28 and an outlet 32 in the upper surface. An airflow passage 34 extends between the inlet 28 and the outlet 32. As best shown in FIG. 3, the passage 34 is trumpet shaped in that the inlet 28 is provided in a region thereof with a larger cross sectional area and narrows towards a throat 36 (shown in FIG. 3) between the inlet 28 and outlet 32. The inlet 28 is in airflow communication with the cockpit 18. A front passage defining region 24.1 of the body adjacent the outlet 32 converges tangentially towards the upper surface 30 and a rear passage defining region 24.2 of the body adjacent the outlet 32 also converges tangentially towards the upper surface 30. Hence, the passage 34 also converges towards the outer surface 30. In use, the upper surface 30 of the extractor body 24 is flush with an outer surface 20.1 (shown in FIG. 1) of the fuselage 20.

The extractor further comprises a flow conditioning arrangement 38 mounted in the passage 34. In the example embodiment, the arrangement comprises at least one wing-shaped body 38 having a head 38.1 and a tail 38.2 and the body is curved from the head to the tail.

The purpose of the flow conditioning arrangement 38 is to accelerate flow in a boundary layer on a rear wall of the extractor, to reduce the difference between the velocity of the ventilation airstream 42 and the external flow velocity and also to fill the velocity profile closest to the surface 20.1 of the craft. As shown in FIG. 4, an additional benefit of the flow conditioning arrangement is that it generates a downward velocity component which reduces the height of the boundary layer behind the extractor. The ventilation airstream 42 in the passage 34 joins the external airstream 44 adjacent the outer surface 20.1 of the craft substantially tangentially.

It is believed that with the resulting negative pressure with reference to ambient pressure in the cockpit 18, air spilling from the cockpit through the cockpit-canopy junction and the associated negative effects thereof, may be reduced. Furthermore, with the expelled ventilation airstream 42 joining the external airstream 44 substantially tangentially, unwanted separation of a boundary layer downstream of the outlet 32 may be reduced.

As described hereinbefore, the extractor 22 generates a negative pressure in the cockpit 18 compared to ambient pressure. This negative pressure may be used as a passive suction source for boundary layer suction on other positions on the craft. For example, and as illustrated in FIG. 5, the negative pressure may be used to apply, through suitable ducting (not shown) boundary layer suction to critical areas on the craft, such as through holes 50 in the nose of the fuselage and/or holes 52 on the main wing, thereby to delay transition of laminar flow to turbulent flow.

It will be appreciated that the craft may, apart from a non pressurized aircraft, such as a light aircraft and glider, be a powerboat, racing car or any other craft, where it is important to expel air from an inner flow field to an outer flow field with limited disturbance of the outer flow field, thereby to inhibit or at least reduce separation of a boundary layer and the resulting drag.

1. A craft comprising a body, a closed cockpit and an air extractor for extracting air from the cockpit, the extractor being mounted on the body in a region of negative pressure relative to general ambient or atmospheric pressure, in use; the extractor comprising a body defining an inlet which is in airflow communication with the cockpit, an outlet and a flow passage extending between the inlet and the outlet; and an air-flow conditioning arrangement mounted in the passage.

2. A craft as claimed in claim 1 wherein the craft is a glider.

3. A craft as claimed in claim 2 wherein the glider comprises an elongate fuselage and a lift providing wing comprising a first wing part on one side of the fuselage and a second wing part on an opposite side of the fuselage and wherein the extractor is mounted in an upper region of the fuselage, between the first and second wing parts.

4. A craft as claimed in any one of claims 1 to 3 wherein the passage is trumpet shaped with the inlet in a region thereof having a larger cross sectional area and wherein the passage converges towards a throat.

5. A craft as claimed in claim 4 wherein the flow conditioning arrangement is provided downstream of the throat.

6. A craft as claimed in any one of claims 1 to 5 wherein the flow conditioning arrangement comprises at least one deflector element having a head and a tail.

7. A craft as claimed in claim 6 wherein more than one deflector element are provided and wherein the deflector elements are mounted parallel to one another .

8. A craft as claimed in any one of claims 6 and 7 wherein an angle of the element relative to a main axis of the passage is adjustable.

9. A craft as claimed in any one of claims 1 to 8 comprising ducting leading from the cockpit to holes in regions of the body of the craft, to apply boundary layer suction to the regions, in use.

10. An air extractor for a cockpit of a craft comprising a body defining an inlet, an outlet and a flow passage extending between the inlet and the outlet; and an air-flow conditioning arrangement mounted in the passage.

11. A retro-fittable kit comprising an air extractor as claimed in claim 9.

12. A method of extracting air from a cockpit of a craft, the method comprising the steps of:
utilizing movement of the craft to generate a negative pressure relative to atmospheric pressure adjacent a region of a body of the craft;
utilizing an outlet located in the region of the body and which outlet is in communication with the cockpit, to cause an airstream to move from the cockpit to the outlet; and
conditioning the airstream to mitigate separation of a boundary layer downstream of the outlet and adjacent the body.

13. A method as claimed in claim 12 comprising the step of causing an airstream moving from the cockpit to join a free airstream adjacent the craft body, substantially tangentially.

14. A method as claimed in claim 13 wherein the airstream moving from the cockpit is caused to join the free airstream substantially tangentially, by deflecting the airstream moving from the cockpit towards an external surface of the craft body.

15. A method as claimed in any one of claims 12 to 14 wherein the negative pressure in the cockpit is utilized to apply boundary layer suction to any part of the body of the craft.
